(19) United States
(12) Patent Application Publication
(10) Pub. No.: US 2008/0132401 A1
(43) Pub. Date: Jun. 5, 2008

(54) OPTICAL GLASS

(75) Inventors: Tomohiro WATANABE, Yokohama-shi (JP); Taihei Mukaide, Atsugi-shi (JP); Hidenosuke Itoh, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/616,704

(22) Filed: Dec. 27, 2006

(30) Foreign Application Priority Data
Dec. 5, 2006 (JP) 328746/2006(PAT.)

(51) Int. Cl. C03C 3/06; C03C 3/062; C03C 3/087

(52) U.S. Cl. 501/54; 501/70; 501/73

(57) ABSTRACT

An optical glass containing Si, Al, Ca, and O is provided. The optical glass contains Si in an amount of 7% or more and 93% or less, in cation percent, Al in an amount of 2% or more and 57% or less, in cation percent, and Ca in an amount of 2% or more and 52% or less, in cation percent. In the optical glass, a total amount of Si, Al, and Ca is 99.5% or more, in cation percent. Further, the optical glass contains Fe and Na each in an amount of 0.01 wtppm or less and has a transmittance to a light having a wavelength of 248 nm of 15% or more at a thickness of 5 mm.

### FIELD OF THE INVENTION AND RELATED ART

The present invention relates to an optical glass used in an apparatus including a light source emitting ultraviolet (UV) rays or vacuum UV rays, particularly an optical glass used as an optical component such as a lens, a prism, or a window member, in regions from UV rays, such as that (wavelength: 248 nm) of a KrF excimer laser, to vacuum UV rays.

In recent years, with a further integration of LSI, development of a photolithographic technology for forming a higher-resolution integrated circuit on a wafer has been required. As a means therefor, the use of a shorter-wavelength light source or a numerical aperture (N.A.) of a projection lens has been considered. As the shorter-wavelength light source, it is possible to use an F₂ laser (wavelength: 157 nm), an extreme ultraviolet (EUV) light source (wavelength: 13 nm), etc. Further, an immersion exposure technology in which a current ArF excimer laser is used and ultrapure water or the like is filled between the projection lens and the wafer has also been a promising technology and has received attention.

As a conventional optical component, such as a lens, a prism, or a window member used in an apparatus employing light ranging from UV rays to vacuum UV rays, synthetic quartz glass or fluorite (CaF₂) having characteristics such as high temperature resistance, high homogeneity, high light resistance, low light dispersion, and a low coefficient of thermal expansion, in combination, has been used.

Synthetic quartz glass is transparent to light in a wide wavelength region from a near-infrared region to a vacuum UV region and its transmittance to a light having a wavelength of 157 nm is 95% at a thickness of 1 cm. Fluorite is transparent to a light having a shorter wavelength than synthetic quartz glass and has a transmittance to the light having the wavelength of 157 nm of 99% or more at a thickness of 10 mm.

Japanese Laid-Open Patent Application 2001-64038 has disclosed a glass material comprising SiO₂, Al₂O₃, B₂O₃, and CaO and containing iron in an amount of 50 ppm or less. This glass material is principally used for carrying a photocatalyst used in a photocatalyst filter or the like and is required to improve a UV-ray transmitting characteristic at a wavelength of 365 nm. A transmittance in a wavelength range of approximately 310-410 nm is improved by using a high-purity starting material, preventing impurity contamination in the glass material production process, and employing a reducing agent. An action of the reducing agent is to reduce an Fe³⁺ ion having an adsorption peak at a wavelength of approximately 365 nm to an Fe²⁺ ion having an absorption peak at a wavelength of approximately 850 nm.

However, a refractive index at a wavelength of 248 nm is 1.51 and 1.47 for synthetic quartz glass and fluorite, respectively, which have been used in the conventional exposure apparatus. Furthermore, fluorite, which is a crystal, has an intrinsic birefringence problem.

In view of these problems, an evaluation of single-crystalline MgO, single-crystalline MgAl₂O₄, and polycrystalline MgAl₂O₄ as a high-refractive index optical member for immersion exposure has been made, e.g., in John H. Burnett, Simon G, Kaplan, Eric L. Shirley, Paul J. Tompkins, and James E. Webb, “High-Index Materials for 193 nm Immersion Lithography, 5754 Proceedings SPIE 611-21 (2005).

According to the evaluation in this document single-crystalline MgO has a refractive index of about 1.82 at a wavelength of 248 nm. Single-crystalline MgAl₂O₄ has a refractive index of about 1.77. Therefore, these materials have sufficient refractive indices for an optical member for a UV wavelength region. Further, with respect to a transmittance at the wavelength of 248 nm, single-crystalline MgO has a transmittance of about 18% at a thickness of 9 mm, single-crystalline MgAl₂O₄ has a transmittance of about 80% at a thickness of 3.4 mm, and polycrystalline MgAl₂O₄ has a transmittance of about 72% at a thickness of 2.7 mm.

However, with respect to intrinsic birefringence at a wavelength of 253.7 nm, single-crystalline MgO has an intrinsic birefringence value of 16.0±0.5 nm/cm (extrapolation value) and single-crystalline MgAl₂O₄ has an intrinsic birefringence value of 14.6±0.1 nm/cm (extrapolation value), thus providing much larger values than that (−0.55±0.07 nm/cm) of CaF₂.

In the above document, a content of iron in the glass material is 50 ppm or less in order to improve a transmittance to UV rays having a wavelength of 365 nm. In the case where the Fe content in glass is 1.0 ppm and Si containing 0.1 ppm of an impurity as a reducing agent is used in an amount of 0.01 wt. %, a transmittance at a wavelength of approximately 248 nm is about 50% at a thickness of 1 mm. In this case, however, the glass material does not have a sufficient refractive index.

### SUMMARY OF THE INVENTION

A principal object of the present invention is to provide an optical glass, which has a high refractive index and a high transmittance and which causes no intrinsic birefringence, in a UV region.

As a result of trying to identify an optical member that has a high refractive index, high transmittance, and high homogeneity and causes no problem of intrinsic birefringence, in a UV region, the present inventors have found that an optical glass that comprises SiO₂ and Al₂O₃ and to which CaO or CaO and MgO are added is effective.

According to a first aspect of the present invention, there is provided an optical glass comprising Si, Al, Ca, and O,

wherein the optical glass contains Si in an amount of 7% or more and 93% or less, in cation percent, Al in an amount of 2% or more and 57% or less, in cation percent, and Ca in an amount of 2% or more and 52% or less, in cation percent, a total amount of Si, Al, and Ca being 99.5% or more, in cation percent, and

wherein the optical glass contains Fe and Na each in an amount of 0.01 wtppm or less and has a transmittance to a light having a wavelength of 248 nm of 15% or more at a thickness of 5 mm.

According to a second aspect of the present invention, there is provided an optical glass comprising Si, Al, Ca, Mg, and O,

wherein the optical glass contains Si in an amount of 40% or more and 60% or less, in cation percent, Al in an amount of 10% or more and 35% or less, in cation percent, and Ca and Mg in a total amount of 20% or more and 35% or less, in cation percent, a total amount of Si, Al, Ca, and Mg being 99.5% or more, in cation percent, and

wherein the optical glass contains Fe and Na each in an amount of 0.01 wtppm or less and has a transmittance to a light having a wavelength of 248 nm of 60% or more at a thickness of 5 mm.

The above-described optical glass may preferably contain an OH group in an amount of 5000 wtppm or less. The above-described optical glass may preferably have a refractive index to a light having a wavelength of 248 nm of 1.7 or more.

According to the present invention, it is possible to provide an optical glass having a high refractive index and a high transmittance in a UV region.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a graph showing wavelength dependence of a transmittance of an optical glass according to an embodiment of the present invention.

FIG. 2 is a graph showing wavelength dependence of a refractive index of the optical glass according to the embodiment of the present invention.

FIG. 3 is a graph showing wavelength dependence of a transmittance of an optical glass according to another embodiment of the present invention.

FIG. 4 is a graph showing wavelength dependence of a refractive index of the optical glass according to another embodiment of the present invention.

### DETAILED DESCRIPTION OF THE PREFERRED EMBODIMENTS

The present invention is described below in detail.

The optical glass according to the present invention has a higher refractive index and a higher transmittance in a UV wavelength region compared with synthetic quartz glass and fluorite.

With respect to oxides, it has been generally known that there is a correlation between a band gap and a refractive index in a visible light region. More specifically, as described in S. H. Wemple and M. DiDomenico, Jr., “Oxygen-octahedral ferroelectrics: 11 Electro-optical and nonlinear-optical device applications”, J. Appl. Phys., vol. 40, pp. 735-752, February (1969), it has been empirically known that the following relationship is satisfied:

n²−1=15/Eg,

wherein n represents a refractive index and Eg represents a band gap (eV).

Here, assuming that there is a similar relationship (correlation) even in wavelength regions from UV rays to vacuum UV rays, when an oxide material having a band gap that is smaller than that (Eg=approximately 9 eV, varying depending on a fictive temperature) of synthetic quartz glass and larger than 5.0 eV corresponding to the energy at a wavelength of 248 nm, it is considered that a glass material having both a high refractive index and a high transmittance can be obtained. For example, MgO has a band gap of 7.6 eV and MgAl₂O₄ has a band gap of 7.75 eV, so that these materials satisfying this condition.

A fluorine-containing material, such as fluorite, has a large band gap, so that it is highly transparent to light of short wavelengths. However, a fluoride ion has a smaller electronic polarizability (1.04×10⁻²⁴ cm³) than that (3.88×10⁻²⁴ cm³) of an oxide ion, so that the fluorine-containing material is undesirable in terms of the high refractive index.

The present inventors have conducted their studies on the basis of the above-described assumption. As a result, SiO₂—Al₂O₃—CaO-based glass and SiO₂—Al₂O₃—CaO—MgO-based glass prepared by adding Al₂O₃ (Eg=8.7 eV) and CaO (Eg=6.8 eV) and/or MgO (Eg=7.6 eV) to SiO₂ have been found. However, with respect to these glass materials (compositions), a study of high purity has been insufficient.

As described above, at the wavelength of 248 nm, synthetic quartz glass has a refractive index of 1.51 and fluorite has a refractive index of 1.47. On the other hand, the above-described SiO₂—Al₂O₃—CaO-based glass has a refractive index of 1.6 at the wavelength of 248 nm.

In a preferred embodiment, the optical glass according to the first aspect of the present invention comprises Si, Al, Ca, and O,

wherein the optical glass contains Si in an amount of 7% or more and 93% or less, in cation percent, Al in an amount of 2% or more and 57% or less, in cation percent, and Ca in an amount of 2% or more and 52% or less, in cation percent, a total amount of Si, Al, and Ca being 99.5% or more, in cation percent, and

wherein the optical glass contains Fe and Na each in an amount of 0.01 wtppm or less and has a transmittance to a light having a wavelength of 248 nm of 30% or more at a thickness of 5 mm.

In another preferred embodiment, the optical glass according to the second aspect of the present invention comprises Si, Al, Ca, Mg, and O,

wherein the optical glass contains Si in an amount of 40% or more and 60% or less, in cation percent, Al in an amount of 10% or more and 35% or less, in cation percent, and Ca and Mg in a total amount of 20% or more and 35% or less, in cation percent, a total amount of Si, Al, Ca, and Mg being 99.5% or more, in cation percent, and

wherein the optical glass contains Fe and Na each in an amount of 0.01 wtppm or less and has a transmittance to a light having a wavelength of 248 nm of 60% or more in a thickness of 5 mm.

The optical glass according to the present invention contains Si.

The amount of Si (Si content) contained in the optical glass according to the first aspect of the present invention is 7% or more and 93% or less, preferably 10% or more and 90% or less, in terms of cation %. In the optical glass of the first aspect of the present invention, a cation % of Si means a ratio of the ion number of a cation of Si to the sum of the ion numbers of the cations of Si, Al, and Ca, on a percentage basis. Similarly, a cation % of Al means a ratio of the ion number of a cation of Al to the sum of the ion numbers of the cations of Si, Al, and Ca, on a percentage basis. Further, a cation % of Ca means a ratio of the ion number of a cation of Ca to the sum of the ion number of the cations of Si, Al, and Ca, on a percentage basis.

The amount of Si (Si content) contained in the optical glass according to the second aspect of the present invention is 40% or more and 60% or less, preferably 45% or more and 55% or less, in terms of cation %. In the optical glass of the second aspect of the present invention, a cation % of Si means a ratio of the ion number of a cation of Si to the sum of the ion numbers of the cations of Si, Al, Ca, and Mg on a percentage basis. Similarly, a cation % of Al means a ratio of the ion number of a cation of Al to the sum of the ion numbers of the cations of Si, Al, Ca, and Mg on a percentage basis. Further, a cation % of Ca means a ratio of the ion number of a cation of Ca to the sum of the ion number of the cations of Si, Al, Ca, and Mg on a percentage basis. Further, a cation % of Mg means a ratio of the ion number of a cation of Mg to the sum of the ion number of the cations of Si, Al, Ca, and Mg, on a percentage basis.

SiO₂ is capable of forming glass by itself and is a frequently used glass component. As described above, SiO₂ has a band gap (Eg) of about 9 eV, so that it exhibits excellent optical transparency and light resistance with respect to UV rays and vacuum UV rays. A refractive index thereof is 1.51 at a wavelength of 248 nm, which is small. Accordingly, the Si content may preferably be increased in order to permit the transmission of short wavelength light, but the increase in the Si content is disadvantageous with respect to the improvement in the refractive index. Further, generally, when the Si content is larger, a resultant material is liable to vitrify and has a small thermal expansion coefficient, thus having an improved stability as glass. However, the viscosity and melting point thereof are increased. This not only means an increase in the energy cost during melting, but also a limitation on a material for a vessel, such as a crucible or the like, thus resulting in an increase in production cost. Therefore, the Si content in accordance with the present invention may be in the above-described range.

The optical glass in the present invention contains Al.

The amount of Al (Al content) contained in the optical glass according to the first aspect of the present invention is 2% or more and 57% or less, preferably 26% or more and 52% or less, in terms of cation %.

The amount of Al (Al content) contained in the optical glass according to the second aspect of the present invention is 10% or more and 35% or less, preferably 15% or more and 30% or less, in terms of cation %.

It is difficult to form glass with Al₂O₃ alone. However, Al₂O₃ is a glass component for improving chemical durability that is added to a so-called glass-forming oxide, such as SiO₂ or the like. Further, Al₂O₃ has a band gap (Eg) of 8.7 eV as described above and high optical transparency with respect to UV rays and vacuum UV rays. Further, compared with SiO₂, Al₂O₃ improves the refractive index, so that the Al content may preferably be in the above-described range.

The optical glass in the present invention contains Ca or Ca and Mg.

The amount of Ca (Ca content) contained in the optical glass according to the first aspect of the present invention is 2% or more and 52% or less, preferably 7% or more and 45% or less, in terms of cation %.

The total amount of Ca and Mg ((Ca+Mg) content) contained in the optical glass according to the second aspect of the present invention is 20% or more and 35% or less, preferably 22% or more and 32% or less, in terms of cation %.

A ratio of Ca:Mg contained in the optical glass according to the second aspect of the present invention is Ca:Mg=(3 or more and 4 or less):(1 or more and 2 or less) in terms of the number of cation.

CaO and MgO are so-called glass formation modifier oxides and are used as a viscosity-lowering components. As described above, CaO has an Eg of 6.8 eV and MgO has an Eg of 7.6 eV, so that they have larger band gaps (Eg) than the energy (5.0 eV) of a KrF excimer laser (wavelength: 248 nm). However, both CaO and MgO are treated as impurities, which decrease transparency to UV rays. Ca—O has a binding energy of 91 kcal/mol and Mg—O has a binding energy of 88 kcal/mol, so that these values of binding energy are smaller than that (150 kcal/mol) of SiO₂ and that (115 kcal/mol) of Al₂O₃, thus resulting in small bond strengths. Therefore, it is preferable to increase the CaO content or the MgO content from the viewpoint of improving the refractive index. On the other hand, it is preferable for the CaO content or the MgO content to be decreased from the viewpoint of increasing the optical transparency and light resistance with respect to UV rays and vacuum UV rays. CaO improves the refractive index better than MgO. However, the optical transparency of MgO to UV rays is greater than that of CaO. Therefore, the Ca content and the (Ca+Mg) content is preferably in the above-described ranges.

With respect to impurities that can be contained in the optical glasses according to the first and second aspects of the present invention, each of Fe and Na is contained in an amount of 0.01 wtppm or less, preferably 0.001 wtppm or less. The term “wtppm” means a weight ratio of Fe or Na to the entire weight of optical glass.

The optical glass according to the present invention is an optical member formed of glass, so that similar to synthetic quartz glass and fluorite that have been employed for the same purpose, it is preferable for the optical glass to contain as little impurity having an absorption peak in UV region as possible. More specifically, it is required in the present invention that high-purity starting materials be used and impurity contamination during the production process be reduced as much as possible.

Oxides of metal elements, examples of which may include oxides of transition metals, such as Ti or Fe, and oxides of alkali metals, such as Na or K, are principal impurities of UV and vacuum UV transmissive materials. It is desirable for these oxides to be substantially excluded from the optical glass of the present invention. Furthermore, it is also desirable to substantially exclude from the optical glass of the present invention other metal oxides having band gaps close to or lower than the UV or vacuum UV energy to be used.

Furthermore, it is desirable for the optical glasses according to the first and second aspects of the present invention contain the OH group in an amount of 5000 wtppm or less, preferably 2000 wtppm or less. The OH group is present close to Ca or Mg and accelerates the destabilization of a network structure of glass. This results in a decrease in light resistance to UV rays or vacuum UV rays. For this reason, the OH group content is preferably as low as possible.

In view of the above-described characteristics of the respective components of the optical glass of the present invention, it is required that the respective contents be adjusted depending on the transmittance and refractive index at an associated wavelength.

The optical glass of the present invention may desirably have a transmittance to a light having a wavelength of 248 nm of 30% or more, preferably 40% or more, at a thickness of 5 mm.

Further, it is desirable for the optical glass of the present invention to have a refractive index to a light having a wavelength of 248 nm of 1.7 or more.

As a process for producing the optical glass of the present invention, as described above, a process capable of eliminating impurity contamination is preferable. More specifically, examples of such a process may include a process in which starting materials are melted by electricity, arc plasma, or flame; a flame hydrolysis procedure; a direct process; a soot remelting process, such as vapor-phase axial deposition (VAD) or modified chemical vapor deposition (MCVD); plasma CVD; sol-gel process; and the like. In any process, it is preferable to use high-purity starting materials.

The present invention is described more specifically below based on Examples. However, the present invention is not limited thereto.

### Example 1

As starting materials, powders of CaO (99.995 wt. %), Al₂O₃ (99.998 wt. %), and SiO₂ (99.999 wt. %) were weighed in at a weight ratio of 37:23:40 and mixed sufficiently in an agate mortar.

After the resultant mixture powder was charged into a platinum vessel having a diameter of about 10 mm and a height of about 30 mm, the powder was melted at 1500° C. in an electric furnace and kept for 2 hours in a melted state. Thereafter, the melted powder was left standing for natural cooling to room temperature by turning off an output of a heater of the electric furnace to obtain an optical glass (material).

As a result of (chemical) composition analysis using fluorescent X-ray spectroscopy, the optical glass contained Si, Al, and Ca at a ratio of Si:Al:Ca=37:23:40, in terms of cation %, and contained Fe in an amount of 0.01 wtppm or less and Na in an amount of 0.01 wtppm or less.

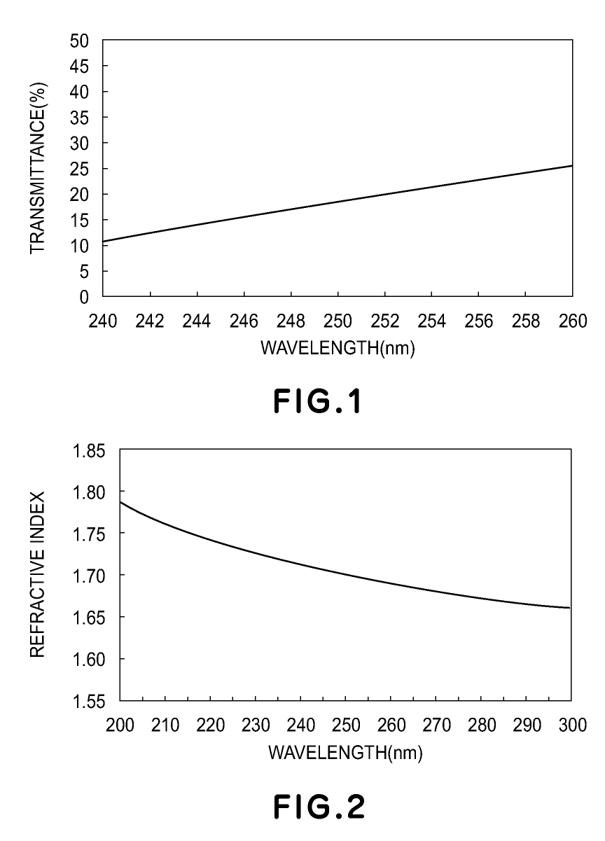

FIG. 1 shows a wavelength dependence of the external transmittance of the glass obtained in this Example.

FIG. 2 shows a wavelength dependence of the refractive index of the glass obtained in this Example.

As a result of the measurement of an external transmittance at a wavelength of 248 nm by means of a visible-ultraviolet spectrophotometer, the measured transmittance was 16.9%.

Further, as a result of the measurement of a refractive index at a wavelength of 248 nm by means of a fast spectroscopic ellipsometer (“M-2000D”, mfd. by J. A. Woolam Co., Inc.), the measured refractive index was 1.70.

### Example 2

An optical glass of an SiO₂—Al₂O₃—CaO—MgO system was prepared in the same manner as in Example 1.

As a starting material for Mg, MgO powder (99.999 wt. %) was used. The respective powders were weighed in at a weight ratio of SiO₂:Al₂O₃:CaO:MgO=42:24:20:14 and mixed sufficiently in an agate mortar.

A temperature during melting in the electric furnace was 1600° C.

As a result of (chemical) composition analysis using fluorescent X-ray spectroscopy, the optical glass contained Si, Al, Ca, and Mg at a ratio of Si:Al:Ca:Mg=42:24:20:14, in terms of cation %, and contained Fe in an amount of 0.01 wtppm or less and Na in an amount of 0.01 wtppm or less.

As a result of the measurement of the OH group concentration, OH group content was about 1400 wtppm.

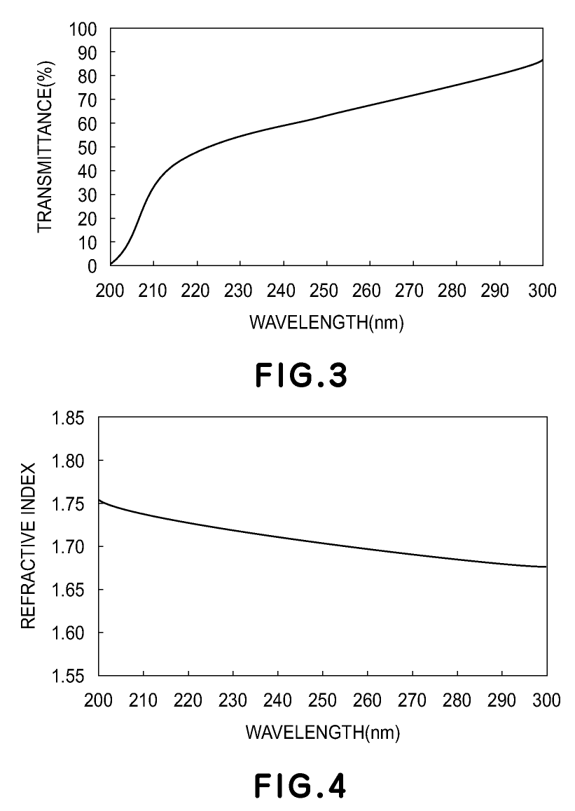

FIG. 3 shows a wavelength dependence of the external transmittance of the glass obtained in this Example.

FIG. 4 shows a wavelength dependence of the refractive index of the glass obtained in this Example.

As a result of the measurement of an external transmittance at a wavelength of 248 nm by means of a visible-ultraviolet spectrophotometer, the measured transmittance was 62%.

Further, as a result of the measurement of a refractive index at a wavelength of 248 nm by means of a fast spectroscopic ellipsometer (“M-2000D”, mfd. by J. A. Woolam Co., Inc.), the measured refractive index was 1.70.

### INDUSTRIAL APPLICABILITY

As described above, according to the present invention, the optical glass has a high refractive index and high transmittance in a UV region, so that it is possible to use the optical glass as an optical part, such as a lens, a prism, a window material, and the like, in a wavelength range from UV rays to vacuum UV rays.

While the invention has been described with reference to the structures disclosed herein, it is not limited to the details set forth and this application is intended to cover such modifications or changes as may come within the purpose of the improvements or the scope of the following claims.

This application claims priority from Japanese Patent Application No. 328746/2006, filed Dec. 5, 2006, which is hereby incorporated by reference.

What is claimed is:

1. An optical glass comprising Si, Al, Ca, and O,
wherein said optical glass contains Si in an amount of 7% or more and 93% or less in cation percent, Al in an amount of 2% or more and 57% or less in cation percent, and Ca in an amount of 2% or more and 52% or less in cation percent, a total amount of Si, Al, and Ca being 99.5% or more in cation percent, and
wherein said optical glass contains Fe and Na each in an amount of 0.01 wtppm or less and has a transmittance, to a light having a wavelength of 248 nm, of 15% or more in a thickness of 5 mm.

2. An optical glass comprising Si, Al, Ca, Mg, and O,
wherein said optical glass contains Si in an amount of 40% or more and 60% or less in cation percent, Al in an amount of 10% or more and 35% or less in cation percent, and Ca and Mg in a total amount of 20% or more and 35% or less in cation percent, a total amount of Si, Al, Ca, and Mg being 99.5% or more in cation percent, and
wherein said optical glass contains Fe and Na each in an amount of 0.01 wtppm or less and has a transmittance, to a light having a wavelength of 248 nm, of 60% or more in a thickness of 5 mm.

3. An optical glass according to claim 1, wherein said optical glass contains an OH group in an amount of 5000 wtppm or less.

4. An optical glass according to claim 1, wherein said optical glass has a refractive index, to a light having a wavelength of 248 nm, of 1.7 or more.

5. An optical glass according to claim 2, wherein said optical glass contains an OH group in an amount of 5000 wtppm or less.

6. An optical glass according to claim 2, wherein said optical glass has a refractive index, to a light having a wavelength of 248 nm, of 1.7 or more.
